(19) United States
(12) Patent Application Publication
(10) Pub. No.: US 2026/0098130 A1
(43) Pub. Date: Apr. 9, 2026

(54) PC SUPPORTED INTERFACE ADDITIVE MASTERBATCH AND USE THEREOF IN PC SOLVENT RESISTANCE MODIFICATION

(71) Applicant: BEIJING AEROSPACE KAIEN NEW MATERIAL CO., LTD., Beijing (CN)

(72) Inventors: Junchi ZHENG, Beijing (CN); Tao FANG, Beijing (CN); Chaoyang LIU, Beijing (CN); Yue JIA, Beijing (CN); Zheng MENG, Beijing (CN); Zhaoyi SUN, Beijing (CN); Jing QIAN, Beijing (CN); Junying AN, Beijing (CN); Yaguang YANG, Beijing (CN); Bangjian SHU, Beijing (CN)

(73) Assignee: BEIJING AEROSPACE KAIEN NEW MATERIAL CO., LTD., Beijing (CN)

(21) Appl. No.: 18/998,904

(22) PCT Filed: Dec. 29, 2023
(86) PCT No.: PCT/CN2023/143230

§ 371 Date: Jan. 27, 2025

(30) Foreign Application Priority Data
Dec. 29, 2022 (CN) 202211718165.3

(51) Int. Cl. C08J 3/22; C08F 2/06; C08F 220/14

(52) U.S. Cl. CPC C08J 3/226; C08F 2/06; C08F 220/14; C08J 2369/00; C08J 2433/12

(57) ABSTRACT

A method for preparing a PC masterbatch loaded with an interfacial conditioning aid and a method for preparing a PC composite are provided. An interfacial conditioning aid is polymerized by methyl acrylate (MA) or an itaconate derivativer, glycidyl methacrylate (GMA), and methyl methacrylate (MMA) as three types of raw material. The interfacial conditioning aid and PC solution are mixed, and co-precipitated to obtain a PC masterbatch loaded with an interfacial conditioning aid. The PC masterbatch loaded with an interfacial conditioning aid, PC, and a polyester are mixed and performed a blend extrusion on the mixed system to obtain the PC composite. The PC composite has good solvent resistance, little color change, good transparency, and excellent physical properties.

This application is based on and claims the priority of Chinese patent application No. CN202211718165.3, filed with the CNIPA on Dec. 29, 2022, the entire contents of which are incorporated herein by reference.

### TECHNICAL FIELD

The present application relates to the technical field of high molecular materials, in particular to an interfacial conditioning aid for modifying solvent resistance of a PC composite, and a method for preparing a PC composite.

### BACKGROUND

Polycarbonate (PC) is a thermoplastic containing a main chain with (O-R-O—CO) links, and has good mechanical properties, as well as good heat resistance and flame retardancy. Although the PC has excellent mechanical, thermal, and optical properties, due to the poor solvent resistance, especially in the environment of organic solvents and alkaline solutions, the PC can be easily caused to swell and crack by stress, resulting in loss of transparency of products and even complete scrapping of the products, which hinders the further application of the PC in various fields to some extent.

There are a large number of ester groups in the PC molecule, so there is a possibility of hydrolysis or alcoholysis in specific environments, causing damage to the structure of the material. On the other hand, a large number of benzene rings and polar groups in the PC gives it a rigid molecular chain, and such PC molecules tend to form irregular long and hard fibril bundles, which are staggered and combined to form a loose network, resulting in a large number of microvoids in a secondary structure of the PC. Thus, it is easier for various solvents to enter the interior of the structure of the material. Common solvents such as methanol, ethanol, isopropanol, acetic acid, benzene and chlorobenzene can cause significant swelling or even dissolution of the PC material, which may reduce the mechanical properties of the product and further form cracks or cause stress cracking.

Composite modification is an important method to improve the solvent resistance of the PC. An aromatic acid saturated polyester has a flexible olefin segment, a largely hindered aromatic hydrocarbon segment and a significantly polar ester group segment. By a conjugated structure between the aromatic hydrocarbon and the ester group, rotation of a molecular chain of the aromatic acid saturated polyester has a significant steric hindrance. Therefore, the aromatic acid saturated polyester is mostly in a long linear chain configuration, and the aromatic hydrocarbon component in the molecular chain are basically on the same plane, thereby making the degree of geometrical and chemical regularity of the molecular chain high. Thus, the aromatic acid saturated polyester has the characteristics of good crystallinity, that is, good chemical resistance and high glass transition temperature, which is precisely suitable for improving the solvent resistance of the PC. By compounding the PC with the aromatic acid saturated polyester, the structural characteristics of the aromatic acid saturated polyester can be fully utilized to fill a large amount of microvoid spaces in the secondary structure of the PC molecule, forming a class of PC composites with good solvent resistance and stress cracking resistance.

However, there is a certain difference in crystallinity between the PC and the aromatic acid saturated polyester, and there is in a phase separation phenomenon by directly compound the PC and the aromatic acid saturated polyester, so it is difficult to achieve the complementarity of the microstructures of the PC and the aromatic acid saturated polyester, and further the effect of the aromatic acid saturated polyester in improving the solvent resistance of the PC cannot be exerted. In addition, when the aromatic acid saturated polyester in the PC is largely aggregated, a certain crystalline region can be formed, thereby greatly reducing the transparency of the material. In order to prepare PC materials with good transparency and good solvent resistance, it is crucial to select an interfacial conditioning aid that can react with both components simultaneously in modifying the PC by introducing the aromatic acid saturated polyester. Both the aromatic acid saturated polyester and the PC have carboxyl. When the interfacial conditioning aid can react with the carboxyl under certain conditions, the binding effect of the PC and the aromatic acid saturated polyester is enhanced, so that the aromatic acid saturated polyester is uniformly dispersed in the PC matrix, self-crystallization is inhibited while the large number of microvoids in the secondary structure of the PC molecule are sufficiently filled. Therefore, the solvent resistance of the PC is improved while maintaining the transparency.

At present, acrylate interfacial conditioning aids with epoxy groups can bind two phases of the PC and the aromatic acid saturated polyester in the PC composite. However, the existing acrylate interfacial conditioning aids with acrylate as a main structure have only the effect of chemically linking the PC with the aromatic acid saturated polyester, which has the problem of insufficient use efficiency. So the effect of improving the solvent resistance of a material obtained by compounding the PC with the aromatic acid saturated polyester is not significant enough. In addition, the interfacial conditioning aid needs to be sufficiently dispersed after being added into the PC composite and then sufficiently reacts with the PC and the aromatic acid saturated polyester, and the role of the interfacial conditioning aid can be effective. It is resulted in that the stronger shear mixing is applied to the composite during processing, and excessive shear mixing results in significant yellowing of the PC, affecting the appearance of the material.

### SUMMARY

A first object of the present application is to improve the solvent resistance of a PC composite at a high temperature. A molecular structure of PC is adjusted by an interfacial conditioning aid, and PC composite compounded of the interfacially modified PC with PC and other polymers has excellent solvent resistance.

A second object of the present application is to further improve both solvent resistance at a high temperature and transparency of a PC composite.

A third object of the present application is to reduce shear mixing during preparation of the PC composite, and maintain the appearance of the composite. A PC component is modified by an interfacial conditioning aid to obtain a PC masterbatch, and the PC masterbatch is compounded with the PC and a polyester material to achieve the above object.

A fourth object of the present application is to prepare a PC composite having solvent resistance at a high temperature and good transparency.

In a first aspect, an interfacial conditioning aid is formed by polymerizing three monomers, i.e., an itaconate derivative or methyl acrylate (MA), glycidyl methacrylate (GMA) and methyl methacrylate (MMA).

A polymer formed by polymerizing the three monomers can modify the structure of a PC. The modified PC is compounded with a polyester to obtain a PC composite of which the solvent resistance can be effectively improved without affecting the transparency of the PC itself.

In a second aspect, a PC masterbatch loaded with an interfacial conditioning aid, prepared by mixing the interfacial conditioning aid with PC in a solvent, and performing co-precipitation.

In the PC masterbatch loaded with an interfacial conditioning aid, the interfacial conditioning aid is pre-dispersed in a PC. By adding the PC masterbatch loaded with an interfacial conditioning aid into a system in which the PC is compounded with the polyester, the PC can be compounded with the polyester under relatively weak shear to prepare a PC composite that does not exhibit yellowing.

In a third aspect, a method for preparing a PC composite includes, blending the PC masterbatch loaded with an interfacial conditioning aid, a PC and a polyester, and performing melt extrusion to obtain the PC composite.

The obtained PC composite has good solvent resistance, little color change, good transparency, and excellent physical properties.

In particular, the interfacial conditioning aid synthetized by polymerizing the three monomers, i.e., the itaconate derivative, glycidyl methacrylate (GMA) and methyl methacrylate (MMA), is used to prepare the PC composite having solvent resistance (e.g., resistance to solvents such as ethanol, acetic acid, and carbon tetrachloride) at a high temperature.

### BRIEF DESCRIPTION OF THE DRAWINGS

FIG. 1 is an infrared spectrum of a copolymer prepared in Example 22.

FIG. 2 shows a solvent resistance test mold.

### DETAILED DESCRIPTION

The interfacial conditioning aid and the method for preparing the PC composite with solvent resistance of the present application is further described in detail below. The protection scope of the present application is not limited, and the protection scope is defined by the claims. The disclosed details are used for thoroughly understanding the various disclosed embodiments. However, one skilled in the art can know that embodiments may be implemented without one or more of these details, and with other materials and the like.

Unless the context requires, in the specification and claims, the term “comprising” or “containing” should be interpreted as an open-end and inclusive meaning, that is, “including, but not limited to”.

The “embodiment”, “an embodiment”, “another embodiment” or “some embodiments” mentioned in the specification refers to that the specific features, structures or characteristics described in the embodiment are included in at least one embodiment. Thus, “an embodiment,” “an embodiment,” “another embodiment,” or “some embodiments” are not necessarily all included in the same embodiment.

Furthermore, the specific features, structures or characteristics may be combined in any manner in one or more embodiments. Each feature disclosed in the specification may be replaced by any alternative feature that can have the same, equivalent or similar function. Therefore, unless otherwise specified, the disclosed features are only general examples of equivalent or similar features.

The present application are be further described below with reference to specific examples. It should be understood that these examples are merely illustrative of the present application and are not intended to limit the scope of the present application. Experimental methods of which specific conditions were not specified in the following examples were generally performed according to conventional conditions or according to the conditions suggested by the manufacturer. All percentages, ratios, proportions, or parts are by weight unless otherwise specified.

Normal temperature in the present application refers to a temperature in the range of 10-40° C.

### Interfacial Conditioning Aid

In a first embodiment, an interfacial conditioning aid is a copolymer polymerized by glycidyl methacrylate, methyl acrylate and methyl methacrylate as raw materials.

Further, glycidyl methacrylate, methyl acrylate, methyl methacrylate and a solvent are added into a reactor, an initiator is added after a temperature is raised to a range of 60-80° C. under a protective atmosphere, and stirring is performed under a protective atmosphere to obtain the copolymer.

Optionally, the initiator is added after the temperature is raised to a range of 60-80° C. under the protective atmosphere and is maintained for 30-60 min under the protective atmosphere.

After the initiator is added, a reaction is kept being carried out under stirring for 6-12 h to obtain the copolymer.

In some embodiments, glycidyl methacrylate is used in an amount of 2-30 wt % of a mass of methyl methacrylate.

Optionally, glycidyl methacrylate is used in an amount of 4-12 wt % of the mass of methyl methacrylate.

Methyl acrylate is used in an amount of 2-15 wt % of the mass of methyl methacrylate.

The amount of the solvent used may be appropriately adjusted based on the amount of the raw materials for the reaction, so that the whole reaction system is subjected to a reaction in a solution.

In some embodiments, methyl methacrylate is added in an amount of 3-20 wt % of the amount of the solvent added.

In the above solutions, by adjusting the amounts of glycidyl methacrylate, methyl acrylate and methyl methacrylate used, the structure of the interfacial conditioning aid can be controlled and the range of application of the interfacial conditioning aid can be improved.

In a second embodiment, an interfacial conditioning aid is a copolymer polymerized by three monomers, i.e., glycidyl methacrylate (GMA), an itaconate derivative, and methyl methacrylate (MMA).

The itaconate derivative includes, but is not limited to, one or a mixture of more than one compound selected from a group consisting of dibutyl itaconate, diisobutyl itaconate, diamyl itaconate, diisoamyl itaconate, dihexyl itaconate, and diheptyl itaconate.

In the interfacial conditioning aid of the present application, the itaconate monomer has an alkane segment with a length of 4-7 carbon atoms, which can impart a certain flexibility to the interfacial conditioning aid. So the interfacial conditioning aid itself can also fill the microvoids in the secondary structure of a PC molecule to a certain extent, resulting in a further improvement in solvent resistance of a PC composite at a high temperature.

The alkane segment of the itaconate monomer refers to a carbon chain on an alcohol for synthesizing an itaconate. A structural formula of dibutyl itaconate is shown below, wherein an alkane carbon segment refers to a carbon chain on butanol.

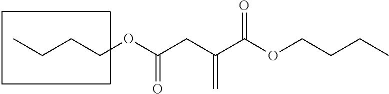 [SMILES: C=C(CC(=O)OCCCC)C(=O)OCCCC]

Theoretically, the key to improving the solvent resistance of PC is to adequately fill a large amount of microvoid spaces in the secondary structure of the PC molecule. In the conventional method, an aid that can simultaneously react with PC and aromatic acid saturated polyester is used to sufficiently bind the polyester to the PC molecule, thereby the microvoid spaces in the secondary structure of the PC molecule are filled with the polyester. In this method, the aid is mainly selected from GMA, a copolymer of GMA and MA, a copolymer of GMA and olefin, or the like, the aid has only the effect of binding PC to the polyester, and the aid itself has no significant effect on filling the microvoids in the secondary structure of the PC molecule, therefore, the effect of improving the solvent resistance of PC is relatively limited. Especially at a high temperature, the microscopic movement speed of small solvent molecules is further increased, and the solvent faster and more intrudes into the microvoids in the PC, which results in a significantly less than ideal effect of conventional interfacial aids in improving the solvent resistance of the PC composite at a high temperature.

In addition to the copolymerization of GMA and MA, the itaconate derivative is copolymerized in the interfacial conditioning aid of the present application, and the alkane structure in the itaconate derivative is in a side chain and has a certain length. This means that the interfacial conditioning aid of the present application is used for sufficiently binding PC to the polyester, and the side chain alkane segment of 4-7 carbon atoms of the itaconate structure is sufficiently present between the PC and the polyester, so the microvoids in the secondary structure of the PC molecule are further filled with the itaconate derived alkane structure, thereby remarkably improving the solvent resistance of the PC. More importantly, the alkane structure has poor affinity with solvents such as alcohols, acids, and furan. When the microvoids in the PC are filled with a large amount of itaconate-derived alkane structures, the solvents such as alcohols, acids, and furan are less likely to enter the structural pores in the PC, which significantly improves the solvent resistance of the PC, resulting in improved solvent resistance of the PC composite at a high temperature. In some embodiments, a mass ratio of an itaconate to methyl methacrylate is 1:(1.3-6.1).

Optionally, the mass ratio of the itaconate to methyl methacrylate is 1:(2.0-3.0).

In some embodiments, a mass ratio of the itaconate to glycidyl methacrylate is 1:(0.025-0.4).

Optionally, the mass ratio of the itaconate to glycidyl methacrylate is 1:(0.02-0.2). By adjusting the addition amounts of the MMA, GMA and itaconate monomers as the above ratios, the structure of the interfacial conditioning aid can be controlled.

In the first and second embodiments, by adjusting the proportion of glycidyl methacrylate, as an active component for reacting with carboxyl in the PC and the aromatic acid saturated polyester, the efficiency of the interfacial conditioning aid can be ensured, and it is avoided excessive crosslinking in the PC composite caused by excessive active components during actual use.

In the polymerizing of the first and second embodiments, the polymerizing is carried out in an organic solvent.

Optionally, the organic solvent is at least one of tetrahydrofuran, N, N-dimethylformamide, and trichloromethane.

Optionally, the organic solvent is tetrahydrofuran.

Generally, in the polymerizing of the second embodiment, the total amount of the three monomers is 5-25 wt % of the amount of the organic solvent.

In some embodiments, during the polymerizing of the first and second embodiments, an initiator is added, and the initiator is selected from at least one of azobisisobutyronitrile (AIBN) and azobisisoheptonitrile (ABVN).

The initiator is added in an amount of 0.05-0.2 wt % (Optionally, 0.1 wt %) of a total mass of the three monomers.

In some embodiments, the polymerizing is performed at a temperature in a range of 60-80° C.

In the polymerizing of the second embodiment, the reaction is carried out in an inert atmosphere, and the reaction time can be determined according to the properties of a specific polymerization product. Optionally, the polymerization time is controlled to be 8-16 h in the present application.

The interfacial conditioning aid prepared in the present application can be used in the preparation of the PC composite for well improving the solvent resistance of the PC composite at a high temperature.

PC masterbatch loaded with an interfacial conditioning aid

The interfacial conditioning aid prepared as the above method is mixed with a polycarbonate to prepare a PC masterbatch loaded with an interfacial conditioning aid.

A method for preparing a PC masterbatch loaded with an interfacial conditioning aid includes:
S1, preparing an interfacial conditioning aid by polymerizing three monomers, i.e., methyl acrylate or an itaconate derivative, glycidyl methacrylate, and methyl methacrylate; and
S2, mixing the interfacial conditioning aid with a polycarbonate solution, and performing co-precipitation to prepare the PC masterbatch loaded with the interfacial conditioning aid.

A solvent in the polycarbonate solution can dissolve the interfacial conditioning aid and the polycarbonate.

Optionally, a first solvent may be selected from chloroalkanes, such as one or a mixture of more than two compounds selected from a group consisting of dichloromethane, dichloroethane, trichloromethane, and trichloroethane.

In some embodiments, in the step S2, the polycarbonate solution has a polycarbonate content of 5-25 wt %.

Optionally, the polycarbonate solution has a polycarbonate content of 10-20 wt %.

The polycarbonate of the present application has a melt index of 2-30 g/10 min at 300° C. under a load of 1.2 kg. This range of the melt index covers the most common polycarbonate types, thereby defining a polycarbonate carrier for the masterbatch. It can be ensured that the prepared masterbatch has good versatility and can be adapted to most polycarbonate composites.

In some embodiments, in the mixture of the interfacial conditioning aid and the polycarbonate solution, an amount of the interfacial conditioning aid is calculated by the raw material methyl methacrylate, and the mass of methyl methacrylate is 10-300% of the mass of the polycarbonate.

Or, the mass of the interfacial conditioning aid is 10-250 wt % of the mass of the polycarbonate; and optionally, the mass of the interfacial conditioning aid is 80-150 wt % of the mass of the PC.

The final amount of the masterbatch used together with the content of the interfacial conditioning aid in the masterbatch determines the amount of the interfacial conditioning aid added into the material. The amount of the interfacial conditioning aid added significantly affects the properties of the material. The content of the interfacial conditioning aid in the masterbatch has little impact on the final use effect.

Relatively, the lower content of the interfacial conditioning aid in the masterbatch is more beneficial to the final material properties, but resulting in a higher amount of the masterbatch used in the material, higher material costs, and lower application values. Therefore, a preferred ratio of the mass of the interfacial conditioning aid to the mass of the polycarbonate is in a range from 80 wt % to 150 wt %.

In some embodiments, the polycarbonate is first dissolved in the first solvent to obtain a first solution; the interfacial conditioning aid is added into the first solution for mixing to obtain a second mixed solution; and the second mixed solution is added into a second solvent to separate out a precipitate of PC loaded with the interfacial conditioning aid. The performance of the second solvent in dissolving PC and the interfacial conditioning aid is lower than that of the first solvent.

The precipitate is subjected to suction filtration, and a filter residue is then washed with the second solvent. The washed filter residue is dried to obtain the PC masterbatch loaded with the interfacial conditioning aid.

The second solvent (which may also be referred to as a precipitant) is a small molecule alcohol.

Optionally, the second solvent is selected from one or a mixture of more of methanol, ethanol, n-propanol, and isopropanol.

The second solvent is added in an amount of 150 wt % or more of a mass of the second mixed solution.

The amount of the second solvent is sufficient to co-precipitate polymers in the second mixed solution.

The polycarbonate solution is mixed with the interfacial conditioning aid at a temperature of 20-40° C.

Optionally, a mixture of the polycarbonate solution and the interfacial conditioning aid is stirred for 30-90 min. The interfacial conditioning aid is pre-dispersed in the masterbatch by mixing two substances in a solution.

A stirring speed can be adjusted according to mixing conditions such as temperature and time. In the present application, when the interfacial conditioning aid prepared in the first embodiment is used to prepare the PC masterbatch loaded with the interfacial conditioning aid, the mixed solution is preferably stirred at a speed of 1000-3000 rpm.

When the interfacial conditioning aid prepared in the second embodiment is used to prepare the PC masterbatch loaded with the interfacial conditioning aid, the mixed solution is preferably stirred at a speed of 500-2000 rpm.

The number of times of washing the precipitate with the second solvent is not limited as long as the first solvent remaining on the precipitate is washed as much as possible. Generally, the precipitate is washed with the second solvent for 3 times.

In some embodiments, the precipitate is vacuum dried at a temperature of 60-100° C. to obtain the PC masterbatch load with the interfacial conditioning aid.

Further, the precipitate washed with the precipitant is dried at a temperature of 60-100° C. for 10-16 h to obtain the PC masterbatch loaded with the interfacial conditioning aid.

In the above solutions, the interfacial conditioning aid and the polycarbonate are fully mixed in the solution to be in a uniformly distributed state. At this time, the precipitant (the second solvent) is added to precipitate the polycarbonate, and the interfacial conditioning aid is uniformly distributed in the polycarbonate. Therefore, in the preparation of a PC composite by the PC-loaded interfacial conditioning aid masterbatch, the shear be required for taking dispersion effect is greatly reduced, and the problem of yellowing PC caused by long-term strong shear is also alleviated.

In the present application, by compounding the PC masterbatch loaded with the interfacial conditioning aid with the PC and other polymers, it can be improved in the solvent resistance of the PC composite and also maintain the transparency and other mechanical properties of the PC composite.

The PC masterbatch loaded with the interfacial conditioning aid can be compounded with the polycarbonate and other polymers by any method known in the art to prepare the PC composite.

The other polymers may be materials such as polyester. The present application preferably employs the following preparation method for a PC composite.

### PC Composite

The above PC masterbatch loaded with the interfacial conditioning aid is used in the preparation of a PC composite. The following solutions are specifically included.

A method for preparing a PC composite includes, mixing the PC masterbatch loaded with the interfacial conditioning aid with raw materials for preparing the PC composite, and directly performing melt extrusion to prepare the PC composite.

Specifically, the method for preparing the PC composite includes, mixing the above PC masterbatch loaded with the interfacial conditioning aid, a polycarbonate, and a polyester to form a mixed system, and performing a blending extrusion on the mixed system to obtain the PC composite.

The polyester includes an aromatic acid saturated polyester, for example, one or more of polyethylene terephthalate, polybutylene terephthalate, and polyethylene terephthalate-1,4-cyclohexanedimethyleneterephthalate.

The interfacial conditioning aid of the present application contains a GMA component in a molecular chain, and the epoxy group can react with carboxyl and hydroxyl present in molecular chains of the PC and the aromatic acid saturated polyester, thereby promoting the aromatic acid saturated polyester to be uniformly dispersed in the material system by fully binding PC, inhibiting self-aggregation of the aromatic acid saturated polyester. A crystallization region in the material system is avoided, the composite is inclined to be in an amorphous state of pure PC, and the transparency is maintained well. The aromatic acid saturated polyester can more effectively make up for a large number of microvoids present in the secondary structure of PC, exerting its solvent erosion resistance characteristics. In particular, after the aromatic acid saturated polyester fully binds to the PC, especially, combined with the effect of the side chain alkane segment in the itaconate derivative in the interfacial conditioning aid, the large number of microvoids present in the secondary structure of the PC can be more effectively compensated, exerting its solvent erosion resistance characteristics at a high temperature.

In some embodiments, a content of the PC masterbatch loaded with the interfacial conditioning aid in the mixed system is in a range of 0.5-60 wt %. Optionally, the content is in a ranged of 1-10 wt %.

The amount of the PC masterbatch loaded with the interfacial conditioning aid used is related to the content of the interfacial conditioning aid in the masterbatch. Generally, the content of the interfacial conditioning aid in the mixed system of the present application is in a range of 0.3-6 wt %.

The content of the PC component in the mixed system is in a range of 1-99 wt %.

The content of the polyester in the mixed system is in a range of 0.5-40 wt %.

PC is also contained in the PC masterbatch. The content of the interfacial conditioning aid in the masterbatch is relatively low when the PC content of the PC masterbatch loaded with the interfacial conditioning aid is high, so the amount of the PC masterbatch loaded with the interfacial conditioning aid is required to be relatively large in the preparation of the PC composite, and the amount of a pure PC component used is relatively low.

In some embodiments, the sum of the PC component and the PC in the PC masterbatch loaded with the interfacial conditioning aid in the mixed system is about in a range of 45-99 wt %. The content of the polyester is in a range of 0.5-40 wt %.

Due to the addition of the PC masterbatch loaded with the interfacial conditioning aid, the shearing force required during the extrusion process is significantly reduced in preparing the PC composite, i.e., the material is subjected to a relatively weak shearing action during processing. Therefore, the problem of PC yellowing caused by long-term strong shear is also alleviated.

In some embodiments, a twin-screw extruder used for preparing PC composite has a length-diameter ratio of 40-48:1, in which a vacuum extraction pressure value of a metering section is set to be in a range of −0.85 MPa to −0.95 MPa, a temperature of each screw section is set to be in the range of 150-260° C., and a rotation speed of a main machine is set to be in a range of 300-500 rpm. A mixed material is fed into the twin-screw extruder through a main feeding port for melt extrusion, and pelletized to obtain the PC composite.

In the preparation of the PC composite of the present application, kneading blocks in a screw combination are reduced, the use of 90-degree and 45-degree screw elements is reduced (that is, the shearing force on the material is reduced), however it is ensured that the interfacial conditioning aid is fully dispersed and bound in the system. So the problem of yellowing of the PC composite is solved.

In another embodiment, the method for preparing the PC composite includes, mixing the above PC masterbatch loaded with the interfacial conditioning aid with a polyester to form a mixed system, and performing a blend extrusion on the mixed system to obtain the PC composite.

The amount of the polycarbonate, interfacial conditioning aid, and polyester used in the mixed system may adopt the solution in the above embodiment.

In some embodiments, the mixed system also includes an antioxidant, such as one or more of an antioxidant 1010 (pentaerythritol tetrakis[beta-(3,5-di-tert-butyl-4-hydroxyphenyl) propionate]), an antioxidant 1076 (octadecyl beta-(3,5-di-tert-butyl-4-hydroxyphenyl) propionate), an antioxidant 168 (tris[2,4-di-tert-butylphenyl]phosphite), and an antioxidant 626 (bis(2,4-di-tert-butylphenol)pentaerythritol diphosphite).

A content of the antioxidant in the mixed system is in a range of 0.2-1 wt %.

The specific operation is as follows.

### (1) Mixing of Raw Materials:

1-99 wt % of the polycarbonate, 0.4-70 wt % of the aromatic acid saturated polyester, 0.4-60 wt % of the PC masterbatch loaded with the interfacial conditioning aid, and 0.2-1 wt % of the antioxidant are added into a high-speed mixer to be mixed to obtain a mixed material.

The aromatic acid saturated polyester may be selected from one or more of the polyesters described above.

The antioxidant may be selected from one or more of the antioxidants described above.

### (2) Melt Extrusion:

For a twin-screw extruder with a length-diameter ratio of 40-48:1, a vacuum extraction pressure value of a metering section is set to be −0.85 MPa to −0.95 MPa, a temperature of each screw section is set to be in the range of 150-260° C., and a rotation speed of a main machine is set to be 300-500 rpm. The mixed material is fed into the twin-screw extruder through a main feeding port for melt extrusion, and pelletized to obtain the corresponding PC composite.

By the method for preparing the PC composite of the present application, the PC composite obtained has good solvent resistance, little color change, good transparency, and good physical properties.

### Advantages of the Present Application are as Follows:

1. the method of preparing the PC masterbatch loaded with the interfacial conditioning aid provided by the present application is simple, easy to control and realize large-scale production. A ratio of each component of the interfacial conditioning aid, and a ratio of the interfacial conditioning aid to the PC solution can be adjusted according to the actual use requirements to obtain the PC masterbatch loaded with the interfacial conditioning aid that is more in line with the production requirements.
2. The use of a PC-loaded chain extender prepared by the method according to the present application in the preparation of the PC composite can effectively improve the solvent resistance of the PC composite without affecting the transparency of PC itself and without affecting the physical properties of the material.
3. The of the PC composite is prepared by the PC masterbatch loaded with the interfacial conditioning aid and with the melt blending process using the low shear. It is avoided to yellow the material, and is improved in the quality of the PC composite.

The interfacial conditioning aid, the PC masterbatch loaded with the interfacial conditioning aid, and the method for preparing the PC composite according to the present application are further illustrated below with reference to specific examples.

In the following examples, the polyester is exemplified by polybutylene terephthalate having a relative viscosity of about 0.85; and the polycarbonate (PC) is a bisphenol A type polycarbonate.

Normal temperature in the following examples and experimental examples refers to a temperature of about 25° C.

### Example 1

Preparation of a PC masterbatch loaded with an interfacial conditioning aid 1000 g of tetrahydrofuran, 200 g of MMA, 4 g of MA, and 4 g of GMA were weighed and mixed in a reaction vessel. The reaction temperature was adjusted to 60° C., 0.208 g of AIBN was added after nitrogen was introduced for 30 min, and a reaction was continued to be carried out under the protection of nitrogen at a stirring speed of 2000 rpm for 12 h to obtain an interfacial conditioning aid for later use. The content of GMA in the interfacial conditioning aid was 2 wt %.

480 g of PC with a brand number of 1609 produced by Luxi Chemical Industry Group Co., Ltd. was dissolved in 960 g of dichloroethane at normal temperature to obtain a solution, the temperature was adjusted to 20° C., the interfacial conditioning aid was added into the PC solution under stirring at 2000 rpm, and stirring was continued to be performed for 20 min to obtain a first mixed solution. The component mass of MMA was 250 wt % of the mass of the PC.

Then 200 ml of anhydrous ethanol was added into the first mixed solution at a speed of 20 ml/min at room temperature to be transferred into a 2 L three-necked flask, and it is kept stirring at a speed of 2000 rpm during the adding process, and the PC and the interfacial conditioning aid were co-precipitated. The separated-out precipitate was taken and washed with absolute ethanol for 3 times, and then dried under vacuum at 60° C. for 16 h to obtain the PC masterbatch loaded with the interfacial conditioning aid.

### Example 2

Preparation of a PC masterbatch loaded with an interfacial conditioning aid 20 kg of tetrahydrofuran, 1 kg of MMA, 150 g of MA, and 80 g of GMA were weighed and mixed in a reaction vessel. The reaction temperature was adjusted to 80° C., 1.23 g of AIBN was added after nitrogen was introduced for 60 min, and a reaction was continued to be carried out under the protection of nitrogen at a stirring speed of 500 rpm for 6 h to obtain an interfacial conditioning aid for later use. The content of GMA in the interfacial conditioning aid was 8 wt %.

10 kg of PC with a brand number of SC-1100R produced by Samsung corporation was dissolved in 100 kg of dichloroethane at normal temperature to obtain a solution, the temperature was adjusted to 40° C., the interfacial conditioning aid was added into the PC solution under stirring at 500 rpm, and stirring was continued to be performed for 80 min to obtain a first mixed solution. The component mass of MMA was 10 wt % of the mass of the PC.

Then 2000 ml of anhydrous methanol was added into the first mixed solution at a speed of 20 ml/min at room temperature, and it is kept stirring at a speed of being maintained to be 500 rpm during the adding process, and the PC and the interfacial conditioning aid were co-precipitated. The separated-out precipitate was taken and washed with absolute methanol for 3 times, and then dried under vacuum at 100° C. for 10 h to obtain the PC masterbatch loaded with the interfacial conditioning aid.

### Example 3

Preparation of a PC Masterbatch Loaded with an Interfacial Conditioning Aid

10 kg of tetrahydrofuran, 1 kg of MMA, 80 g of MA, and 100 g of GMA were weighed and mixed in a reaction vessel. The reaction temperature was adjusted to 70° C., 1.18 g of AIBN was added after nitrogen was introduced for 40 min, and a reaction was continued to be carried out under the protection of nitrogen at a stirring speed of 1000 rpm for 10 h to obtain an interfacial conditioning aid for later use. The content of GMA in the interfacial conditioning aid was 10 wt %.

1 kg of PC with a brand number of CLARNATE2100 produced by Yantai Wanhua was dissolved in 10 kg of trichloroethane at normal temperature to obtain a solution, the temperature was adjusted to 30° C., the interfacial conditioning aid was added into the PC solution under stirring at 1000 rpm, and stirring was continued to be performed for 60 min to obtain a first mixed solution. The component mass of MMA was 100 wt % of the mass of the PC.

Then 400 ml of anhydrous n-propanol was added into the first mixed solution at a speed of 20 ml/min at room temperature, and it is kept stirring at a speed of 1000 rpm during the adding process, and the PC and the interfacial conditioning aid were co-precipitated. The separated-out precipitate was taken and washed with anhydrous n-propanol for 3 times, and then dried under vacuum at 80° C. for 13 h to obtain the PC masterbatch loaded with the interfacial conditioning aid.

### Example 4

Preparation of a PC Masterbatch Loaded with an Interfacial Conditioning Aid

12 kg of tetrahydrofuran, 1.5 kg of MMA, 80 g of MA, and 150 g of GMA were weighed and mixed in a reaction vessel. The reaction temperature was adjusted to 70° C., 1.73 g of AIBN was added after nitrogen was introduced for 50 min, and a reaction was continued to be carried out under the protection of nitrogen at a stirring speed of 1500 rpm for 8 h to obtain an interfacial conditioning aid for later use. The content of GMA in the interfacial conditioning aid was 10 wt %.

1 kg of PC with a brand number of CLARNATE2100 produced by Yantai Wanhua was dissolved in 7 kg of trichloroethane at normal temperature to obtain a solution, the temperature was adjusted to 30° C., the interfacial conditioning aid was added into the PC solution under stirring at 1500 rpm, and stirring was continued to be performed for 50 min to obtain a first mixed solution. The component mass of MMA was 150 wt % of the mass of the PC.

Then 600 ml of anhydrous methanol was added to the first mixed solution at a speed of 20 ml/min at room temperature, and it is kept stirring at a speed of 1500 rpm during the adding process, and the PC and the interfacial conditioning aid were co-precipitated. The separated-out precipitate was taken and washed with anhydrous methanol for 3 times, and then dried under vacuum at 90° C. for 11 h to obtain the PC masterbatch loaded with the interfacial conditioning aid.

### Examples 5-9

A method for preparing a PC masterbatch loaded with an interfacial conditioning aid in Examples 5-9 basically referred to that in Example 1, except that only the content of GMA in the interfacial conditioning aid and the amount of an initiator added were changed, as shown in the following table:
the content of GMA in Table 1 refers to the amount relative to methyl methacrylate in the interfacial conditioning aid.

TABLE 1

| | Content of GMA | Amount of GMA | Amount of AIBN |
|---|---|---|---|
| | (wt %) | (g) | (g) |
| Example 5 | 4 | 8 | 0.212 |
| Example 6 | 8 | 16 | 0.22 |
| Example 7 | 12 | 24 | 0.228 |
| Example 8 | 20 | 40 | 0.244 |
| Example 9 | 30 | 60 | 0.264 |

### Examples 10-13

A method for preparing a PC masterbatch loaded with an interfacial conditioning aid in Examples 10-13 basically referred to that in Example 2, except that only the content of MA in the interfacial conditioning aid relative to MMA and the amount of an initiator added were changed, as shown in the following table:
the content of MA in Table 2 refers to the content based on the amount of methyl methacrylate added in the interfacial conditioning aid.

TABLE 2

| | Content of MA | Amount of MA | Amount of AIBN |
|---|---|---|---|
| | (wt %) | (g) | (g) |
| Example 10 | 12 | 120 | 1.20 |
| Example 11 | 9 | 90 | 1.17 |
| Example 12 | 6 | 60 | 1.14 |
| Example 13 | 3 | 30 | 1.11 |

The present application also provides use of the PC masterbatch loaded with the interfacial conditioning aid in the preparation of a PC composite, which is further illustrated in Examples 14-21 below.

### Examples 14-19

### Preparation of a PC Composite

In Examples 14-19, PC composites were prepared by using the PC masterbatch loaded with the interfacial conditioning aid obtained by the preparation method in Example 2, and a specific method was as follows.

PC, polyethylene terephthalate, the PC masterbatch loaded with the interfacial conditioning aid prepared by the method in Example 2, and an antioxidant were mixed in a certain ratio (as shown in Table 3) to obtain a mixed material, and the mixed material was fed to a twin-screw extruder through a main feeding port for melt extrusion, and pelletized to obtain the PC composite. The twin-screw extruder (equipped with the screws generating a weak shear, with one set of kneading blocks, and two sets of 90-degree and 45-degree screw elements) with a length-diameter ratio of 40:1 was selected, in which a vacuum extraction pressure value of a metering section was set to be −0.95 MPa, the temperature of each screw section was set to be in the range of 150-260° C., and a rotation speed of a main machine was set to be 500 rpm.

TABLE 3

| | | | PC | | |
|---|---|---|---|---|---|
| | | | masterbatch | | |
| | | | loaded | | |
| | | | with the | Antioxi- | Antioxi- |
| | PC | Ethylene | interfacial | dant | dant |
| | (SC-1100R)/ | terephthal- | conditioning | 1076/ | 168/ |
| | parts by | ate/parts | aid/parts by | parts by | parts by |
| | weight | by weight | weight | weight | weight |
| Example | 80 | 9.7 | 10 | 0.1 | 0.2 |
| 14 | | | | | |
| Example | 70 | 9.7 | 20 | 0.1 | 0.2 |
| 15 | | | | | |
| Example | 60 | 9.7 | 30 | 0.1 | 0.2 |
| 16 | | | | | |
| Example | 50 | 9.7 | 40 | 0.1 | 0.2 |
| 17 | | | | | |
| Example | 40 | 9.7 | 50 | 0.1 | 0.2 |
| 18 | | | | | |
| Example | 30 | 9.7 | 60 | 0.1 | 0.2 |
| 19 | | | | | |

### Example 20

### Preparation of a PC Composite

In the example, a PC composite was prepared by using the PC masterbatch loaded with the interfacial conditioning aid prepared by the preparation method in Example 3, and a specific method was as follows.

70 parts by weight PC (CLARNATE 2100, Yantai Wanhua), 19.5 parts by weight polybutylene terephthalate, 10 parts by weight the PC masterbatch loaded with the interfacial conditioning aid prepared by the method in Example 3, 0.2 parts by weight an antioxidant 1076, and 0.3 parts by weight an antioxidant 626 were added into a high-speed mixer to be mixed for 5 min to obtain a mixed material.

The mixed material was fed into a twin-screw extruder through a main feeding port for melt extrusion, and pelletized to obtain the PC composite. The twin-screw extruder (equipped with the screws generating a weak shear, with one set of kneading blocks, and two sets of 90-degree and 45-degree screw elements) with a length-diameter ratio of 48:1 was selected, in which a vacuum extraction pressure value of a metering section was set to be −0.85 MPa, the temperature of each screw section was set to be in the range of 150-260° C., and a rotation speed of a main machine was set to be 300 rpm.

### Example 21

### Preparation of a PC Composite

In the example, a PC composite was prepared by using the PC masterbatch loaded with the interfacial conditioning aid prepared by the preparation method in Example 4, and a specific method was as follows.

94 parts by weight PC (CLARNATE 2100, Yantai Wanhua), 2.5 parts by weight polybutylene terephthalate, 3 parts by weight the PC masterbatch loaded with the interfacial conditioning aid prepared by the method in Example 4, 0.2 parts by weight an antioxidant 1076, and 0.3 parts by weight an antioxidant 626 were added into a high-speed mixer to be mixed for 5 min to obtain a mixed material.

The mixed material was fed into a twin-screw extruder through a main feeding port for melt extrusion, and pelletized to obtain the PC composite. The twin-screw extruder (equipped with the screws generating a weak shear, with one set of kneading blocks, and two sets of 90-degree and 45-degree screw elements) with a length-diameter ratio of 48:1 was selected, in which a vacuum extraction pressure value of a metering section was set to be −0.9 MPa, the temperature of each screw section was set to be in the range of 150-260° C., and a rotation speed of a main machine was set to be 400 rpm.

### Example 22

### Preparation of an Interfacial Conditioning Aid

5000 g of tetrahydrofuran, 250 g of diisoamyl itaconate, 720 g of MMA, and 30 g of GMA were mixed. The temperature was adjusted to 70° C., 1 g of AIBN (azobisisobutyronitrile) was added after nitrogen was introduced for 45 min, and a reaction was continued to be carried out under the protection of nitrogen at a stirring speed of 2000 rpm for 12 h to obtain an interfacial conditioning aid copolymer. The content of GMA in the interfacial conditioning aid copolymer was calculated to be 3%.

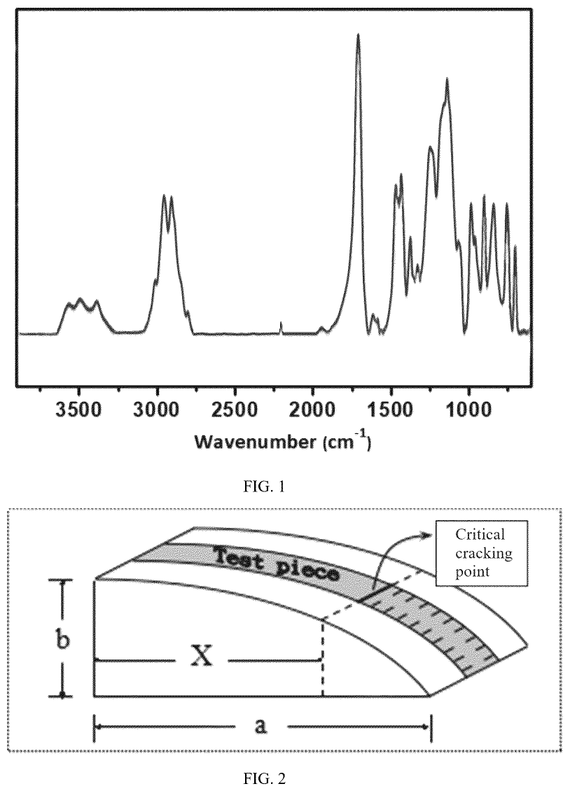

The interfacial conditioning aid copolymer prepared in the example was subjected to infrared spectroscopy, as shown in an infrared spectrum in FIG. 1. In the spectrum, there are stretching vibration peaks of ˜CH₂— and —CH₃ at 2950 cm⁻¹ and 2870 cm⁻¹, corresponding to the alkane structures of diisoamyl itaconate and MMA in the copolymer. There is a stretching vibration peak of carbonyl at 1730 cm⁻¹, corresponding to the ester structural unit of GMA, MMA and itaconate in the copolymer. There is an epoxy group at 910 cm⁻¹, corresponding to the epoxy structural unit of GMA in the copolymer. The copolymer of GMA-MMA-diisoamyl itaconate is confirmed by the presence of the above structural units. PC used in Examples 23 and 25 as well as Comparative examples 1 and 2 below was CLARNATE 2100 produced by Yantai Wanhua, of which the performance parameters were as follow: a melt index of 10 g/10 min at a temperature of 300° C. under a load of 1.2 kg.

### Example 23

### Preparation of a PC Composite

S1, 1 kg of PC and 6 kg of trichloromethane were mixed at a temperature of 30° C. with stirring at a speed of 2000 rpm to prepare a solution having a PC content of 14.29 wt %. Under the condition of keeping the temperature and stirring conditions constant, 1 kg of the interfacial conditioning aid copolymer prepared in Example 22 was added into the above PC solution, and stirring was continued to be performed for 60 min to obtain a mixed solution of the interfacial conditioning aid and the PC. In the mixed solution, the mass of the interfacial conditioning aid was 100 wt % of the mass of the PC.
S2, The mixed solution of the interfacial conditioning aid and the PC in step S1 was added into a 30 L container filled with anhydrous isopropanol, and stirring was performed at a speed of 800 rpm. After the PC and the interfacial conditioning aid are co-precipitated. The precipitate was subjected to suction filtration, the filtered precipitate was washed with anhydrous methanol for 3 times, and the washed precipitate was dried under vacuum at 80° C. for 13 h to obtain a PC masterbatch loaded with the interfacial conditioning aid.
S3, 80 parts by weight PC, 15 parts by weight polybutylene terephthalate, 4.5 parts by weight the PC masterbatch loaded with the interfacial conditioning aid, 0.2 parts by weight an antioxidant 1076 (octadecyl beta-(3,5-di-tert-butyl-4-hydroxyphenyl) propionate) and 0.3 parts by weight an antioxidant 626 (bis(2,4-di-tert-butylphenol) pentaerythritol diphosphite) were added into a high-speed mixer to be mixed at a speed of 125 rpm for 3 min to obtain a PC mixed material. The mixed material was fed into a twin-screw extruder through a main feeding port for melt extrusion, and pelletized to obtain the PC composite.

Parameters of the twin-screw extruder were as follows: a length-diameter ratio was 48:1; the screws are combined by generating a weak shear; one set of kneading blocks, and two sets of 90-degree and 45-degree screw elements were used; and a vacuum extraction pressure value of a metering section was set to be −0.85 MPa, the temperature of each screw section was set to be in the range of 150-260° C., and a rotation speed of a main machine was set to be 300 rpm.

### Comparative Example 1

In this Comparative example, a PC composite was prepared with reference to the method in the step S3 of Example 23, except that 84.5 parts by weight PC, 15 parts by weight polybutylene terephthalate, 0.2 parts by weight an antioxidant 1076 (octadecyl beta-(3,5-di-tert-butyl-4-hydroxyphenyl)propionate), and 0.3 parts by weight an antioxidant 626 (bis(2,4-di-tert-butylphenol)pentaerythritol diphosphite) were added into a high-speed mixer to be mixed at 125 rpm for 3 min to obtain a PC mixed material without an interfacial conditioning aid. The mixed material was fed into a twin-screw extruder through a main feeding port for melt extrusion, and pelletized to obtain the PC composite.

### Comparative Example 2

5000 g of tetrahydrofuran, 720 g of MMA, 250 g of MA, and 30 g of GMA were mixed in a reaction vessel. The reaction temperature was adjusted to 80° C., 1 g of AIBN (azobisisobutyronitrile) was added after nitrogen was introduced for 60 min, and a reaction was continued to be carried out under the protection of nitrogen at a stirring speed of 500 rpm for 6 h to obtain an interfacial conditioning aid. The content of GMA in the interfacial conditioning aid was 3 wt %, and a monomer methyl acrylate replaced diisoamyl itaconate in Example 22 of the application.

In the Comparative example, a PC composite was also prepared with reference to the method in Example 23. The interfacial conditioning aid contained in the PC masterbatch loaded with the interfacial conditioning aid was the interfacial conditioning aid prepared in the Comparative example.

### Comparative Example 3

In the Comparative example, a PC composite was prepared with reference to the method in Example 23, except that in the step S3, 82 parts by weight PC, 15 parts by weight polybutylene terephthalate, 2.5 parts by weight a commercial compatibilizer LOTADER® AX8900, 0.2 parts by weight an antioxidant 1076 ((octadecyl beta-(3,5-di-tert-butyl-4-hydroxyphenyl) propionate)), and 0.3 parts by weight an antioxidant 626 (bis(2,4-di-t-butylphenol) pentaerythritol diphosphite) were added into a high-speed mixer to be mixed at 125 rpm for 3 min to obtain a PC mixed raw material containing the commercial compatibilizer. The mixed material was fed into a twin-screw extruder through a main feeding port for melt extrusion, and pelletized to obtain the PC composite.

The compatibilizer LOTADER® AX8900 is an ethylene-methyl acrylate-glycidyl methacrylate terpolymer, which replaced the interfacial conditioning aid copolymer prepared in Example 22 compared with Example 23 of the present application.

### Example 24

### Preparation of an Interfacial Conditioning Aid

2000 g of tetrahydrofuran, 90 g of dibutyl itaconate, 195 g of MMA, and 15 g of GMA were mixed. The temperature was adjusted to 75° C., 0.3 g of azobisisoheptonitrile (ABVN) was added after nitrogen was introduced for 35 min, and a reaction was continued to be carried out under the protection of nitrogen at a stirring speed of 1500 rpm for 13 h to obtain an interfacial conditioning aid copolymer. The content of GMA in the interfacial conditioning aid copolymer was calculated to be 5%.

### Example 25

### Preparation of a PC Composite

S1, 200 g of PC and 1800 g of dichloromethane were mixed at a temperature of 35° C. with stirring at a speed of 2500 rpm to prepare a solution having a PC content of 10 wt %. Under the condition of keeping the temperature and stirring conditions constant, 300 g of the interfacial conditioning aid copolymer was added into a container, and stirring was continued to be performed for 80 min to obtain a mixed solution of the interfacial conditioning aid and the PC. In the mixed solution, the mass of the interfacial conditioning aid was 150 wt % of the mass of the PC.
S2, The mixed solution of the interfacial conditioning aid and the PC in step S1 was added into a 10 L container filled with anhydrous ethanol, and stirring was performed at a speed of 600 rpm. After the PC and the interfacial conditioning aid are co-precipitated, the precipitate was subjected to suction filtration, the filtered precipitate was washed with anhydrous methanol for 3 times, and the washed precipitate was dried under vacuum at 90° C. for 12 h to obtain a PC masterbatch loaded with the interfacial conditioning aid.
S3, 95 parts by weight PC, 2.5 parts by weight polybutylene terephthalate, 2 parts by weight the PC masterbatch loaded with the interfacial conditioning aid, 0.2 parts by weight an antioxidant 1076 (octadecyl beta-(3,5-di-tert-butyl-4-hydroxyphenyl)propionate) and 0.3 parts by weight an antioxidant 626 (bis(2,4-di-tert-butylphenol)pentaerythritol diphosphite) were added into a high-speed mixer to be mixed at a speed of 125 rpm for 3 min to obtain a PC mixed raw material. The mixed material was fed into a twin-screw extruder through a main feeding port for melt extrusion, and pelletized to obtain the PC composite.

Parameters of the twin-screw extruder were as follows: a length-diameter ratio was 48:1, and the screws are combined for generating a weak shear. Specifically, one set of kneading blocks, and two sets of 90-degree and 45-degree screw elements were used; and a vacuum extraction pressure value of a metering section was set to be −0.9 MPa, the temperature of each screw section was set to be in the range of 150-260° C., and a rotation speed of a main machine was set to be 400 rpm.

### Comparative Example 4

A method for preparing a PC composite in the Comparative example referred to the processes and parameters in step S3 of Example 24, except that the PC masterbatch loaded with the interfacial conditioning aid was changed to a commercial polymer of a GMA-MA-styrene structure (GP301) as the interfacial conditioning aid.

### Comparative Example 5

A method for preparing a PC composite in the Comparative example referred to the processes and parameters in step S3 of Example 24, except that the PC masterbatch loaded with the interfacial conditioning aid was changed to a commercial polymer of a GMA-MA-styrene structure (GP301) as the interfacial conditioning aid; and the twin-screw extruder had 3 sets of kneading blocks, 5 sets of 90-degree and 45-degree screw elements. That is, the mixed material was extruded with a strong shear force to obtain the PC composite.

The PC masterbatch loaded with the interfacial conditioning aid as well as the performance of the PC composite were tested as follows.

### Experimental Example 1

The PC masterbatches loaded with the interfacial conditioning aid prepared in Examples 1 and 5-9 were tested in the Experimental example, and an experimental method was as follows.

25 parts by weight PC (Luxi Chemical Industry Group Co., Ltd. 1609), 70 parts by weight polybutylene terephthalate, 4.7 parts by weight the PC masterbatch loaded with the interfacial conditioning aid prepared in Examples 1 and 5-9, 0.1 parts by weight an antioxidant 1076, and 0.2 parts by weight an antioxidant 168 were added into a high-speed mixer to be mixed at 125 rpm for 5 min. The obtained mixed material was sheared in a Haake torque rheometer at a temperature of 250° C. at a rotor speed of 60 rpm, and changes in torque during mixing of the materials were tested; and the test results are shown in Table 4:

TABLE 4

| | | | Torque value |
|---|---|---|---|
| | GMA | Balancing | (N · m) |
| | content | torque value | after mixing |
| | (wt %) | (N · m) | for 10 min |
| Example 1 | 2 | 4.6 | 4.6 |
| Example 5 | 4 | 7.1 | 7.2 |
| Example 6 | 8 | 11.3 | 11.5 |
| Example 7 | 12 | 13.5 | 13.8 |
| Example 8 | 20 | 14.5 | 17.3 |
| Example 9 | 30 | 15.2 | 19.9 |
| Comparative | 0 | 3.7 | 3.7 |
| example 1 | | | |

The GMA content of 0% in Comparative example 1 in Table 4 indicates that no interfacial conditioning aid was used. A mixed material was prepared by 29.7 parts by weight PC, 70 parts by weight polybutylene terephthalate, 0.1 parts by weight an antioxidant 1076, and 0.2 parts by weight an antioxidant 168. Mixing was also performed for 5 min by using a high-speed mixer, and testing was performed by using a Haake torque rheometer. The process parameters were shown as the above.

As can be seen from Table 4, as the content of GMA in the interfacial conditioning aid increases, the balancing torque of the material gradually rises, which indicates that the PC binds to the GMA under the action of the interfacial conditioning aid, thereby illustrating the effectiveness of chain extension. Further, it can be seen that when the GMA content is lower than 4%, the torque value is significantly reduced, and it is relatively small improvement in torque value compared with that without adding a PC masterbatch loaded the interfacial conditioning aid. When the GMA content is higher than 12%, the torque value is still increased, the increasing is not significant compared with the increasing in GMA content. So it can be seen from the above table that the preferred content of GMA is 4-12 wt %.

### Experimental Example 2

The PC composite in Examples 14-19 was tested in the experimental example. Specifically, a melt index of the PC composite was measured by using a melt index meter at 250° C. and 2.16 kg. The measurement results are as follows.

TABLE 5

| | | PC masterbatch loaded | |
|---|---|---|---|
| | | with an interfacial | Melt |
| | PC (SC-1100R)/ | conditioning aid/ | index/ |
| | parts by weight | parts by weight | (g/10 min) |
| Example | 80 | 10 | 9.3 |
| 14 | | | |
| Example | 70 | 20 | 8.0 |
| 15 | | | |
| Example | 60 | 30 | 6.9 |
| 16 | | | |
| Example | 50 | 40 | 6.1 |
| 17 | | | |
| Example | 40 | 50 | 5.4 |
| 18 | | | |
| Example | 30 | 60 | 4.8 |
| 19 | | | |

As can be seen from the above Table 5, the melt index of the material gradually decreases with the increase in the amount of the PC masterbatch loaded with the interfacial conditioning aid, which indicates that the PC binds with polybutylene terephthalate under the action of the interfacial conditioning aid, thereby increasing the viscosity of the material. So it was further confirmed the effectiveness of the interfacial conditioning aid prepared in the present application.

### Experimental Example 3

The solvent resistance of the PC composite of the present application was tested under normal temperature conditions in the experimental example.

A test piece was prepared into a sample strip of 230×30×2 mm, the sample strip was fixed to a semi-elliptical mold as shown in FIG. 2, and a gauze was immersed in different solvents, and then the gauze was placed on the test piece to maintain sufficient adsorption of the solvent in the gauze, wherein the test time was 24 hours. After the test piece was taken out and wiped, the test piece was observed for cracking and a critical deformation value 8% was calculated. Where 8% is calculated by the following formula: ε%=b/2a²[1−(a²−b²)X²/a⁴]^{-3/2}*t*100, where a long axis a=190 mm, a short axis b=77 mm, and the thickness of the sample strip t=2 mm.

The corresponding determination standard is shown in Table 6:

TABLE 6

| | | Whether the PC | |
|---|---|---|---|
| | Conditions for stress | composite can be | |
| | cracking of | applied in a | |
| | workpieces caused | situation in contact | |
| ε % | by solvents | with a solvent | Grade |
| Below 0.3 | Slight daily use | Unusable | A |
| | strain causes | | |
| | cracking | | |
| 0.3-0.5 | Normal daily use | Not recommended | B |
| | strain causes | for use | |
| | cracking | | |
| 0.5-0.8 | Large strain changes | Be used only | C |
| | in daily use causes | under special | |
| | cracking | conditions | |
| 0.8-2.0 | Cracking is only | In general, daily | D |
| | caused by extremely | applications have | |
| | high daily strain | no concern | |
| | changes | | |
| Above 2.0 | Strain changes in | Be used unless | E |
| | daily use do not | there are extreme | |
| | cause cracking | stress situations | |

In the experimental example, the solvent resistance of the PC composite in Example 20 and the PC composite prepared without using the interfacial conditioning aid was tested, Specifically, after the PC composite was subjected to injection molding to obtain sample plates, the sample plates were soaked with organic solvents such as carbon tetrachloride, methanol, and acetic acid, and the sample plates were taken out after 72 h, the erosion of the sample plates was compared. The comparison results were shown in Table 7 below.

TABLE 7

| | | Acetic | Carbon |
|---|---|---|---|
| | Ethanol | acid | tetrachloride |
| Example 20 | No change | No change | Slight cracking |
| Comparative | No change | Slight | Severe cracking, |
| Example 2 | | cracking | surface |
| | | | delamination |

It should be noted that in Comparative example 2 of the above Table 7, a mixed material was prepared by 80 parts by weight PC (CLARNATE 2100, Yantai Wanhua), 19.5 parts by weight polybutylene terephthalate, 0.2 parts by weight an antioxidant 1076, and 0.3 parts by weight an antioxidant 626, and a PC mixed material without the PC masterbatch loaded with interfacial conditioning aid was also obtained by mixing for 5 min by using a high-speed mixer. The PC composite was obtained by the melt extrusion method of Example 20. Tests were performed in different solvents.

As can be seen from Table 7 above, the solvent resistance of the PC composite prepared in Example 20 by the PC masterbatch loaded with the interfacial conditioning aid was significantly improved compared with that of the PC composite prepared without using the PC masterbatch loaded with the interfacial conditioning aid.

Four types of PC composite in Example 23, Comparative example 1, Comparative example 2 and Comparative example 3 were subjected to injection molding to obtain sample plates, and the sample plates were subjected to impregnation treatment by using organic solvents such as carbon tetrachloride, methanol, and acetic acid at normal temperature. The erosion of the sample plates was compared, a critical deformation value 8% was compared, and the corresponding grades were determined, and the results are shown in Table 8. Through comparison, it can be seen that the solvent resistance of the material prepared by masterbatch loaded with the interfacial conditioning aid of the present application was significantly improved at normal temperature compared with that without masterbatch loaded with the interfacial conditioning aid and using the commercial compatibilizer.

TABLE 8

| | | Product of | Product of | Product of |
|---|---|---|---|---|
| | Product of | Comparative | Comparative | Comparative |
| Solvent type | Example 23 | example 1 | example 2 | example 3 |
| Ethanol | E | E | E | E |
| Acetic acid | E | C | E | D |
| Carbon | D | A | D | B |
| tetrachloride | | | | |

### Experimental Example 4

In the experimental example, the solvent resistance of the PC composite of the present application at a high temperature of 60° C. was tested.

The detection method and the determination standard were the same as those in Experimental example 3.

Four PC composites in Example 23, Comparative example 1, Comparative example 2 and Comparative example 3 were subjected to injection molding to obtain sample plates, and the sample plates were subjected to impregnation treatment by organic solvents such as carbon tetrachloride, methanol, and acetic acid in a space of 60° C. The erosion of the sample plates was compared, a critical deformation value 8% was compared, and the corresponding grades were determined, and the results are shown in Table 9. Through comparison, it can be seen that the solvent resistance of the material prepared by the masterbatch loaded with the interfacial conditioning aid of the present application is significantly improved at a high temperature. Compared with the commercial compatibilizer of the ethylene-methyl acrylate-glycidyl methacrylate terpolymer structural system and an interfacial aid of a GMA-MMA-MA system in the previous patent application CN202211718165.3, the interfacial aid of the GMA-MMA-itaconate derivative system of the present application also has obvious improvement in the solvent resistance of the PC composite at a high temperature.

TABLE 9

| | | Product of | Product of | Product of |
|---|---|---|---|---|
| | Product of | Comparative | Comparative | Comparative |
| Solvent type | Example 23 | example 1 | example 2 | example 3 |
| Ethanol | E | D | E | E |
| Acetic acid | E | B | D | C |
| Carbon | D | A | C | A |
| tetrachloride | | | | |

### Experimental Example 5

In the Experimental example, the solvent resistance, optical properties, color difference, mechanical properties, and the like of the PC composite were tested.

Transparency and haze were tested by using the standard ASTM D1003-2021 “Standard Test Method for Haze and Luminous Transmittance of Transparent Plastics”.

A color difference value was tested by using GB/T 3979-2008 “Methods for measurement of object color”, a value b is taken, which represents yellow and blue, a positive value is a yellow phase, and the greater the value, the more yellow the color of the object.

The tensile strength of the material was tested by using the standard GB/T 1040-2006 “Plastics—Determination of tensile properties” at a stretching rate of 50 mm/min.

The flexural strength of the material was tested by using the standard GB/T 9341-2008 “Plastics—Determination of flexural properties” at a test rate of 2 mm/min.

The notched impact strength of the material was tested by using the standard GB/T 1843-2008 “Plastics—Determination of izod impact strength”.

The solvent resistance of the material at a high temperature of 60° C. was tested by using the method described in Experimental example 3 and Experimental example 4 of the present application.

The performance of the PC composite described in Example 21 and the PC composite prepared by using the commercial interfacial conditioning aid were tested. Specifically, the color difference value, transparency, basic mechanical properties, etc. were tested after the PC composites were injection molding to obtain sample plates, and the test results are shown in Table 10 below:

TABLE 10

| | | Comparative | Comparative |
|---|---|---|---|
| Test item | Example 21 | example 3 | example 4 |
| Transparency (%) | 85 | 82 | 75 |
| Haze (%) | 3 | 4 | 10 |
| Color difference | −0.32 | 0.87 | 0.13 |
| value b | | | |
| Tensile strength | 71 | 70 | 67 |
| (MPa) | | | |
| Flexural strength | 92 | 90 | 82 |
| (MPa) | | | |
| Notched impact | 72 | 71 | 58 |
| strength (kJ/m²) | | | |
| Soaking in | No change | No change | No change |
| ethanol | | | |
| Soaking in acetic | No change | No change | No change |
| acid | | | |
| Soaking in carbon | Slight | Slight | Significant |
| tetrachloride | cracking | cracking | cracking |

The PC composite in Comparative example 3 and Comparative example 4 prepared by the commercial interfacial conditioning aid under different shear strengths was tested, respectively. The specific preparation process was as follows: a mixture containing 95.2 parts by weight PC (CLARNATE 2100, Yantai Wanhua), 2.5 parts by weight polybutylene terephthalate, 1.8 parts by weight a commercial interfacial conditioning aid GP301, 0.2 parts an antioxidant 1076, and 0.3 parts an antioxidant 626 was mixed in a high-speed mixer for 5 min to obtain a mixed material using the commercial interfacial conditioning aid. Twin-screw extruders equipped with the screws generating a weak shear (one set of kneading blocks, and two sets of 90-degree and 45-degree screw elements) and the screws generating a strong shear (3 sets of kneading blocks, and 5 sets of 90-degree and 45-degree screw elements) with a length-diameter ratio of 48:1 were selected for melt extrusion, wherein a vacuum extraction pressure value of a metering section of the extruder was set to be −0.9 MPa, the temperature of each screw section was set to be in the range of 150-260° C., and a rotation speed of a main machine was set to be 400 rpm. After pelletizing, two types of PC composite using the commercial interfacial conditioning aid were obtained.

Comparative example 3 is the result of the PC composite extruded under strong shear, and Comparative example 4 is the result of the PC composite extruded under weak shear.

As can be seen from the table, by using the PC masterbatch loaded with the interfacial conditioning aid prepared in the present application, the interfacial conditioning aid is sufficiently dispersed in the material under the condition that the extruder is equipped with the screws generating the weak shear combination. The PC composite has good transparency, low yellowing, and excellent physical properties and solvent resistance.

The solvent resistance, optical properties, color difference, mechanical properties, and the like of the PC composites in Example 24, Comparative example 4, and Comparative example 5 were tested. The results are shown in Table 11.

By comparison, it can be seen that the masterbatch loaded with the interfacial conditioning aid prepared in the present application can effectively improve the solvent resistance of the material at a high temperature, and has a more obvious effect than that of the commercial interfacial conditioning aid of the GMA-MA-styrene structure.

Meanwhile, as can be seen from the comparison of Comparative example 4 and Comparative example 5, by using the commercial compatibilizer, it is necessary to ensure the basic mechanical properties of the material and the solvent resistance of the material by increasing the shearing action of the screw (increasing the number of kneading and reversing screw sets) in the case where the masterbatch is not used, but the yellowing of the material becomes severe at this time. Whereas by comparing Example 24 with Comparative example 4, it was found that in the same case of using the weak shear screw combination, the interfacial aid can be dispersed by the masterbatch prepared by the method of the present application, and reacted more rapidly in the material system. Thereby the mechanical properties, solvent resistance and optical properties of the material were very excellent, and the material was not yellowed.

TABLE 11

| | | | |
|---|---|---|---|
| Test item/solvent | | Comparative | Comparative |
| type | Example 24 | example 4 | example 5 |

Optical properties and color difference

| | | | |
|---|---|---|---|
| Transparency | 87 | 73 | 81 |
| (%) | | | |
| Haze (%) | 3 | 10 | 5 |
| Color difference | −0.21 | 0.20 | 0.92 |
| value b | | | |

Mechanical properties

| | | | |
|---|---|---|---|
| Tensile strength | 75 | 67 | 73 |
| (MPa) | | | |
| Flexural strength | 96 | 81 | 94 |
| (MPa) | | | |
| Notched impact | 78 | 53 | 76 |
| strength (kJ/m²) | | | |

Solvent resistance

| | | | |
|---|---|---|---|
| Ethanol | E | D | E |
| Acetic acid | E | C | C |
| Carbon | D | A | A |
| tetrachloride | | | |

### Experimental Example 6

In the experimental example, some types of PC composite were prepared by using PC masterbatches loaded with the interfacial conditioning aid with different MA contents prepared in Example 2, and Example 10 to Example 13, respectively, and the properties of the PC composites were tested as follows.

70 parts by weight PC (SC-1100R), 9.7 parts by weight polybutylene terephthalate, 20 parts by weight the PC masterbatch loaded with the interfacial conditioning aid prepared by the method in Example 2, 0.1 parts by weight an antioxidant 1076, and 0.2 parts by weight an antioxidant 168 were mixed, and added into a high-speed mixer to be mixed for 5 min.

A twin-screw extruder (equipped with screws generating a weak shear, with one set of kneading blocks, and two sets of 90-degree and 45-degree screw elements) with a length-diameter ratio of 40:1 was selected, a vacuum extraction pressure value of a metering section was set to be −0.95 MPa, the temperature of each screw section was set to be in the range of 150-260° C., and a rotation speed of a main machine was set to be 500 rpm. The mixed material was fed into the twin-screw extruder through a main feeding port for melt extrusion, and then pelletized to obtain the PC composite. After the PC composite was subjected to injection molding to obtain sample plates, the basic mechanical properties and melt index (250° C., 2.16 kg) were tested, and the test results are shown in Table 12 below:

TABLE 12

| | | Melt index/ | Notched impact | Flexural |
|---|---|---|---|---|
| | MA content | (g/10 | strength | strength |
| | (wt %) | min) | (kJ/m²) | (MPa) |
| Example 2 | 15 | 8.0 | 83 | 75 |
| Example 10 | 12 | 7.9 | 79 | 78 |
| Example 11 | 9 | 7.7 | 75 | 80 |
| Example 12 | 6 | 7.6 | 72 | 83 |
| Example 13 | 3 | 7.4 | 69 | 85 |

As can be seen from the above table, as the MA content in the interfacial conditioning aid increases, the melt index of the material decreases slightly, the notched impact strength decreases gradually, and the flexural strength increases gradually. Based on the trend of performance changes, the MA content in the interfacial conditioning aid structure can be designed according to the needs of the final material properties to achieve targeted adjustment of the properties of the PC composite.

1. A method for preparing a PC masterbatch loaded with an interfacial conditioning aid, including:
S1, preparing an interfacial conditioning aid by polymerizing by an itaconate derivative or methyl acrylate, glycidyl methacrylate and methyl methacrylate as raw materials; and
S2, mixing the interfacial conditioning aid with a polycarbonate solution, and performing co-precipitation to prepare the PC masterbatch loaded with the interfacial conditioning aid.

2. The method according to claim 1, wherein, in step S1, glycidyl methacrylate, methyl acrylate, methyl methacrylate and a solvent are added into a reactor,
a temperature is raised to 60-80° C. under a protective atmosphere, and
an initiator is added, and stirring is performed under a protective atmosphere to obtain the interfacial conditioning aid.

3. The method according to claim 2, wherein, after the temperature is raised to 60-80° C. under the protective atmosphere and is maintained for 30-60 min under the protective atmosphere, the initiator is added, wherein, the initiator being an azo initiator;
wherein an amount of the initiator is 0.1 wt % of a sum of the amounts of glycidyl methacrylate, methyl acrylate and methyl methacrylate;
after the initiator is added, a reaction is carried out under stirring for 6-12 h to obtain the interfacial conditioning aid.

4. The method according to claim 1, wherein, an amount of glycidyl methacrylate is 2-30 wt % of a mass of methyl methacrylate;
wherein an amount of methyl acrylate is 2-15 wt % of the mass of methyl methacrylate; and
wherein an amount of methyl methacrylate is 3-20 wt % of the amount of the solvent.

5. The method according to claim 1,
wherein in step S2, a content of polycarbonate in the polycarbonate solution is 5-25 wt %.

6. The method according to claim 1, wherein, in step S2,
the polycarbonate is first dissolved in a first solvent to obtain a first solution; the interfacial conditioning aid is added into the first solution for mixing to obtain a second mixed solution; and the second mixed solution is added into a second solvent to separate out a precipitate of PC loaded with the interfacial conditioning aid; wherein a performance of the second solvent in dissolving PC and the interfacial conditioning aid is lower than that of the first solvent;
the precipitate is subjected to suction filtration, and a filter residue is then washed with the second solvent, and a washed filter residue is dried to obtain the PC masterbatch loaded with the interfacial conditioning aid; and
wherein the second solvent is a small molecule alcohol.

7. The method according to claim 6, wherein, the second solvent washed with the precipitant is dried at a temperature of 60-100° C. for 10-16 h to obtain the PC masterbatch loaded with the interfacial conditioning aid.

8. The method according to claim 1, wherein, in step S1, the interfacial conditioning aid is polymerized by an itaconate derivative, glycidyl methacrylate, and methyl methacrylate; and
wherein the itaconate derivative is prepared by esterification of itaconic acid with a saturated monohydric alcohol containing 4-7 carbon atoms.

9. The method according to claim 8, wherein, a mass ratio of an itaconate to methyl methacrylate is 1:(1.3-6.1); and
wherein a mass ratio of the itaconate to glycidyl methacrylate is 1:(0.025-0.4).

10. (canceled)

11. The method according to claim 1, wherein, during a polymerizing process, an initiator is added, the initiator is selected from at least one of azobisisobutyronitrile and azobisisoheptonitrile; and
, wherein an amount of the initiator is 0.05-0.2 wt % of a total mass of the three monomers.

12. A PC masterbatch loaded with an interfacial conditioning aid, being prepared by a method including:
S1, preparing an interfacial conditioning aid by polymerizing by an itaconate derivative or methyl acrylate, glycidyl methacrylate and methyl methacrylate as raw material;
S2, mixing the interfacial conditioning aid with a polycarbonate solution, and performing co-precipitation to prepare PC masterbatch loaded with the interfacial conditioning aid; and
wherein a mass of the interfacial conditioning aid is 10-250 wt % of a mass of the polycarbonate.

13. The PC masterbatch loaded with an interfacial conditioning aid according to claim 12, wherein, the polycarbonate is first dissolved in the first solvent to obtain a first solution; the interfacial conditioning aid is added into the first solution for mixing to obtain a second mixed solution; and the second mixed solution is added into a second solvent to separate out a precipitate of PC loaded with the interfacial conditioning aid, wherein a performance of the second solvent in dissolving PC and the interfacial conditioning aid is lower than that of the first solvent; and
, wherein the second solvent comprises an alcohol.

14. A method for preparing a PC composite, including:
mixing the PC masterbatch loaded with an interfacial conditioning aid
with a polycarbonate and a polyester to form a mixed system, and performing a blend extrusion on the mixed system to obtain the PC composite; or,
mixing the PC masterbatch loaded with an interfacial conditioning aid with a polyester component to form a mixed system, and performing the blend extrusion on the mixed system to obtain the PC composite;
wherein, the polyester is an aromatic acid saturated polyester; and
wherein, the PC masterbatch loaded with an interfacial conditioning aid is prepared by a method including:
S1, preparing an interfacial conditioning aid by polymerizing by an itaconate derivative or methyl acrylate, glycidyl methacrylate and methyl methacrylate as raw material;
S2, mixing the interfacial conditioning aid with a polycarbonate solution, and performing co-precipitation to prepare PC masterbatch loaded with the interfacial conditioning aid; and
wherein a mass of the interfacial conditioning aid is 10-250 wt % of a mass of the polycarbonate.

15. The method according to claim 14, wherein, a content of the PC masterbatch loaded with the interfacial conditioning aid in the mixed system is 0.5-60 wt %; and
, wherein a content of the PC in the mixed system is 1-99 wt %.

16. The method according to claim 14, wherein, a content of the interfacial conditioning aid in the mixed system is 0.3-6 wt %; and
wherein the content of the polyester in the mixed system is 0.5-40 wt %.

17. (canceled)

18. (canceled)

19. The method according to claim 8, wherein, the itaconate derivative comprises one or a mixture of more than one of dibutyl itaconate, diisobutyl itaconate, diamyl itaconate, diisoamyl itaconate, dihexyl itaconate, and diheptyl itaconate.

20. The method according to claim 8, wherein, the polymerizing is performed at a temperature in a range of 60-80° C.

21. The PC masterbatch loaded with an interfacial conditioning aid according to claim 12, wherein, the first solvent is selected from chloroalkanes.

22. The PC masterbatch loaded with an interfacial conditioning aid according to claim 13, wherein, a PC component is mixed with the interfacial conditioning aid at a temperature of 20-40° C.

23. The method according to claim 15, wherein, a content of the polyester in the mixed system is 0.5-40 wt %.
